(19) United States
(12) Patent Application Publication
(10) Pub. No.: US 2020/0013013 A1
(43) Pub. Date: Jan. 9, 2020

(54) DYNAMICALLY GENERATING AND MANAGING FLIGHT ROUTINGS USING A LOGISTICS MANAGEMENT SYSTEM (LMS)

(71) Applicants: Neeraj Kumar, Eagan, MN (US); Sue M. Dohm, Apex, NC (US); Karen J. Berg, Eagan, MN (US); Venkatesh Pazhyanur, Eagan, MN (US)

(72) Inventors: Neeraj Kumar, Eagan, MN (US); Sue M. Dohm, Apex, NC (US); Karen J. Berg, Eagan, MN (US); Venkatesh Pazhyanur, Eagan, MN (US)

(73) Assignee: Unisys Corporation, Blue Bell, PA (US)

(21) Appl. No.: 16/572,502

(22) Filed: Sep. 16, 2019

Related U.S. Application Data
(63) Continuation of application No. 14/294,226, filed on Jun. 3, 2014, now abandoned.

(51) Int. Cl. G06Q 10/08; G06Q 10/02

(52) U.S. Cl. CPC G06Q 10/08355; G06Q 10/02

(57) ABSTRACT

A logistics management system (LMS) may generate routes dynamically without the overhead of any pre-defined specifications of airport to connect between origin and destination airports. Further, the LMS's route construction function may take into account all the available flights segments, the shipment characteristics such as bulk/pallet/container, shipment product codes, and/or minimum connection times. A method may include receiving a request to create an allotment reservation having an origin and a destination. The method may also include receiving and assigning at least one route generation attribute; receiving available routes that have the same origin and destination as the reservation request; and sorting routes based upon at least one sort order.

### TECHNICAL FIELD

The instant disclosure relates to a logistics management system. More specifically, the instant disclosure relates to dynamically creating and managing flight routings, along with the associated shipment characteristics, using a logistics management system, especially when there is a multitude of flight routings.

### BACKGROUND

An allotment is a block of space onboard an aircraft. An allotment is created as a division of the total space available within the aircraft for shipping cargo, thereby affording air carriers the ability to sell quantifiable spaces onboard the cargo holds of an aircraft. The specific characteristics and dimensions of an allotment are dependent upon several variables, including the characteristics and capabilities of the particular aircraft (e.g., the particular position of an allotment within aircraft's cargo hold may limit the allotment's dimension or weight). An additional consideration in managing allotment reservations is identifying the best route for the customer's shipment.

Carriers have manually pre-defined routes and airports from all possible origin airports to all possible destination airports. Thus, the possible options to define routes from origin airports to destination airports run in hundreds. There is substantial effort required in maintaining these pre-defined routes, which is labor intensive and time consuming. In addition, manually pre-defined routes are not quickly adaptive to changing market conditions, e.g., new flights, flight diversions, flight cancellations, changes of flight times or connection airports, and change of equipment. Other deficiencies of manually pre defined routes include the inability to alleviate airports (or particular flights) which are experiencing higher than usual traffic or are experiencing significant delays or outages. Additionally, manually pre-defined routes cannot quickly and dynamically leverage airports (or particular flights) that have low demand.

### SUMMARY

In one embodiment, a logistics management system (LMS) may create and manage thousands of different routes and flights segments without having to rely upon the time and expense associated with manually pre-defined routes and connection airports. A logistics management systems (LMS) provides computing resources to process freight shipment data, and attempt to aid in scheduling, coordinating and tracking various aspects of the freight shipment. A logistics management system (LMS), in one embodiment, may be configured to generate routes dynamically without the overhead of any pre-defined specifications of airport to connect between origin and destination airports. Further, the LMS's route construction function may take into account all the available flights segments, the shipment characteristics, such as bulk/pallet/container, shipment product codes, and/or minimum connection times. The LMS may also he configured to allow the creation of rules to handle exceptions. The routes generated by the LMS are made available instantaneously and in real-time mode.

According to one embodiment, a method may include receiving a request to create an allotment reservation having an origin and a destination. The method may also include receiving and assigning at least one route generation attribute; receiving available routes that have the same origin and destination as the reservation request; and sorting routes based upon at least one sort order.

According to another embodiment, a computer program product includes a non-transitory computer readable medium having code to receive a request to create an allotment reservation having an origin and a destination. The medium may also include code to receive and assign at least one route generation attribute; receive available routes that have the same origin and destination as the reservation request; and sort routes based upon at least one sort order.

According to another embodiment, a system includes a memory and at least one processor. The at least one processor is coupled to the memory. The at least one processor may be configured to receive a request to create an allotment reservation having an origin and a destination; to receive and assign at least one route generation attribute; receive available routes that have the same origin and destination as the reservation request; and sort routes based upon at least one sort order.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a list of configuration parameters for a Flights and Routings module according to one embodiment of the disclosure.

FIG. 2 is a block diagram illustrating flight routings according to one embodiment of the disclosure.

FIG. 3 is a block diagram illustrating a user interface for a Flight and Routing module, used for creating Routing Generation Attributes, according to one embodiment of the disclosure.

FIG. 4 is a flow chart illustrating a dynamic route generation process according to one embodiment of the disclosure.

FIG. 5 is block diagram illustrating a data management system configured to store databases, tables, and/or records according to one embodiment of the disclosure.

FIG. 6 is a block diagram illustrating a data storage system according to one embodiment of the disclosure.

FIG. 7 is a block diagram illustrating a computer system according to one embodiment of the disclosure.

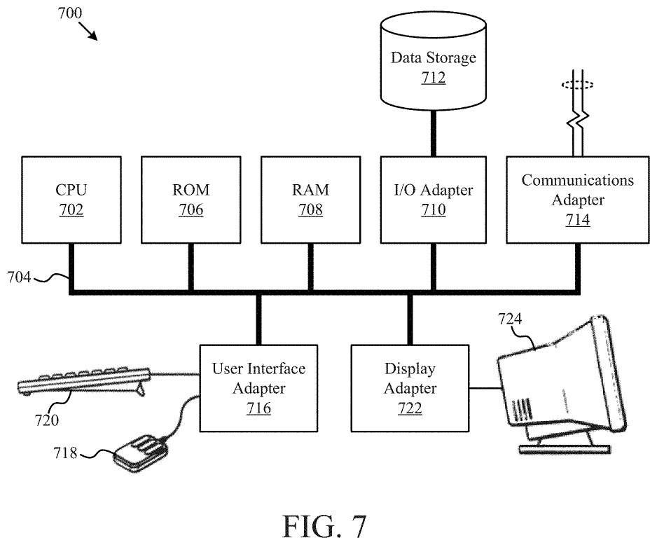

### DETAILED DESCRIPTION

A Flight and Routings module may be configured to provide route constructions, and may be combined with a Flight Control module of a Logistics Management System (EMS). The Flight Control module may perform the functions of (1.) maintaining flights and/or schedules, (2.) managing schedule changes, and/or (3.) providing routes for origin/destination pair for specific shipment characteristics. Shipment characteristics may include the ‘Shipment Type’ and ‘Shipment Delivery Service Level’. Thus, a user may choose to use the Flight Control module or the Flight and Routings module to construct a route. The Flights and Routings module may dynamically generate routes, which may provide airlines the benefits of immediate access to booking capacity when the aircraft and truck schedules change. By incorporating a Flights and Routings module, a LMS may provide On-Demand route construction capability without the overhead of maintaining route construction points (“H” cards or pre-defined routes between an origin and destination). In some embodiments, route construction using the Flight and Routings module may take into account the shipment characteristics, such as products, containerization, and minimum connection times, which will be implemented by allowing a user and/or administrator to specify the rules for handling exceptions. Manual flight changes through current LMS functions of flight information and flight maintenance may be served by a Flight Control module. The updates created by manual changes may be reflected in the Flights and Routings module such that corresponding information is available for subsequent route requests.

Possible values for the shipment characteristics may include values for shipment type and shipment delivery service level. The shipment type may indicate bulk shipment if the loose goods are received as individual packages and handled as loose cargo or may indicate containerized shipment for shipments that are loaded onto a pallet or ULD for transportation purposes. The shipment delivery service level may be set corresponding to pickup and/or delivery commitments agreed to by an air carrier and shipper. The service level may be, for example, express service level for small parcel shipments, time definite delivery for a range of service performance standards offered by air freight carriers (e.g., same day, next day, third day), and/or normal service level for shipment delivery with less tariff and standard delivery schedule.

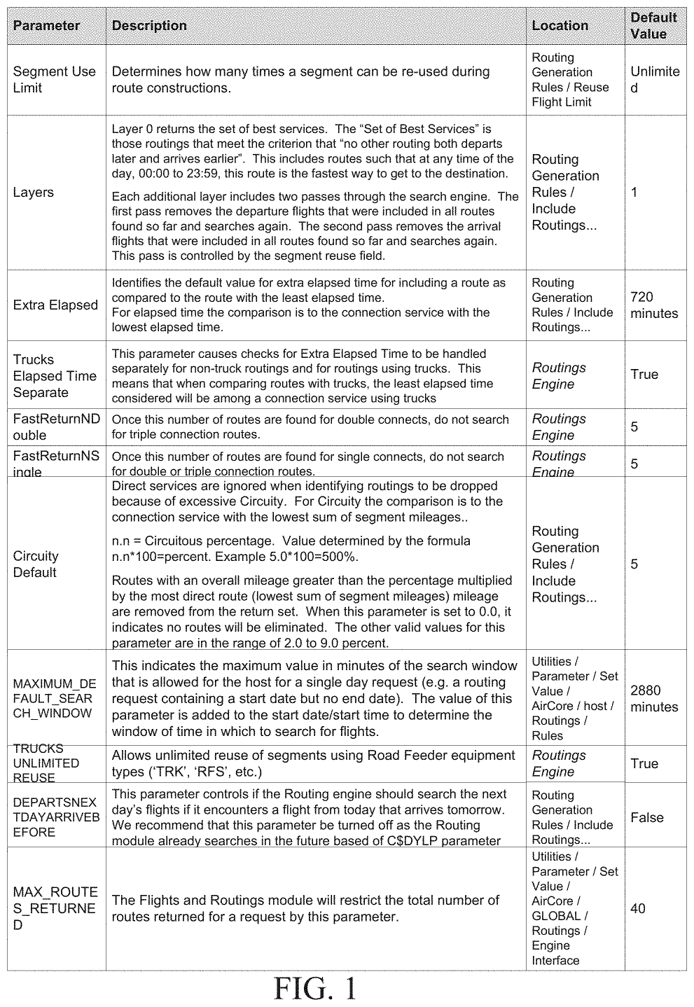

To influence the returned routes for a request, in one embodiment, the Flights and Routings system administrator can set up rules in the Flights and Routings module through “Route Generation Rules” or “Routing Template Rules.” These rule interfaces may allow the carrier to set up specific considerations for specific origins, destinations, origin and destination pairs, and/or day of the week. The considerations may include forcibly including or excluding certain connection points or equipment. Configuration rules may be setup in the Routing module to assist in selection of routes based on schedule and feasibility. When a routing request is made, the best connections (such as up to four flight segments per routing) may be constructed dynamically based on Request parameters. Available flight data (schedule), Minimum connect time (MCT) data, Elapse time, and/or Departure time. FIG. 1 is a block diagram illustrating a list of such configuration parameters for a Flights and. Routings module according to one embodiment of the disclosure.

The routes identified by a Routings Engine, a component of the Flights and Routings module, may be selected to meet certain criterion, such as that no other routing both departs later and arrives earlier. This may include routes such that at any time of the day, 00:00 to 23:59, the route is the fastest way to get to the destination. The routes may be further categorized by layers. In some embodiments, the Routings Engine removes the routes from layer 0 and puts them into the solution set. It then returns to select the next set of routes (another layer, for example layer 1). The Routings Engine adds these routes of layer 1 into the solution set. It then returns again to select the next set of routes (another layer, for example layer 2). In this manner, routes may be built layer by layer.

In one embodiment, a Flight and Routings module may be configured to allow a carrier to add rules for routing selection. These rules may define the rules for controlling the generation and ordering of routings. As an example, an LMS may generate routing information for a destination/origin pair without any airline specific rules by using the Routings Engine defaults and the input options from the routing request. The carrier-defined rules may fall into three categories:
Routing generation attributes, which define criteria such as: particular airlines to include or exclude in a routing, connection points to include or exclude in a routing, number of stops and connections to allow in a routing, flight service types to be used in a routing, and/or routing quantity (best routing or additional routings with same flights, longer elapsed time and longer distances).
Template routings for an airport pair. A template routing defines the airlines or airline and flight numbers for use in segments of routings for a specific airport pair.
Sort order of generated routings for the airline. Sort order rules allow the airline to specify how the returned routings should be sorted.

In some embodiments, the above rules may have an implicit hierarchy with those rules more specific to the request condition superseding the more generic rules that apply to the request conditions. Some rules are restricted, to certain levels of the hierarchy and, all have effective periods. Rules are allowed in the following hierarchical order:
Airline—A rule that applies to all routings for an airline (applied to all rules types);
City Pair—A rule that applies to all routing for specified city pair (routing generation); and
Airport Pair—A rule that applies to all routings for the specified airport pair (routing generation, and template).

In one embodiment, rules for cities, airports, city pairs, and airport pairs may be defined to apply directionally. If the rule is entered to apply only in one direction, a separate rule is allowed in the other direction. For rules related to cities and airports, the rules are defined to apply either into, out of, or both into and out of the city or airport. For rules related to city pairs or airport pairs, the rules are defined to apply from the origin to the destination only or in both directions.

In one embodiment, Routing Generation Rules, Template Routings, and. Sort Order rules may be unique at their permitted hierarchical levels. Routing requests may use the rule information to control the routing generation process. In addition, certain request options may override these rules, Routing generation attributes may be allowed at the airline, city pair, or airport pair levels of the rule hierarchy. The routing generation attributes specify the data used to generate routings, the types of routings that are generated, and the number of routings generated, which are described in greater detail below and shown in exemplary user interface, 300. The quantity of routings may be controlled by a Routing Generation Layer, a Reuse Flight Limit, a Maximum Elapsed Time Differential, and/or a Maximum Mileage Differential selections. The selections are pre-populated from the next higher level in the hierarchy as defaults (city pair or airline if airport pair, airline if city pair). This may guide the user to maintain consistency and change only what is the exception at the lower level in the hierarchy,

In one embodiment, the number of routings generated may be controlled by the Flight and Routing module. Factor for controlling the quantity of generated routings may include: (1.) Routing Layers; (2.) Maximum Elapsed Time Differential; (3.) Maximum Mileage Differential; (4.) Best Service Limit; and/or (5.) Reuse Flight Limit. Routing layers may broaden the search beyond the “Set of Best Services” to find additional connection routings, Maximum Elapsed Time Differential and Reuse Flight Limit may increase the number of routings beyond the “Set of Best Services” that are retained. The Routing Layer (one-nine) may define how far beyond the Set of Best Services routings (zero) that the Routings generation process should go to attempt to find additional routings. The “Set of Best Services” may include routings that meet the criterion that “no other routing both departs later and arrives earlier.” This may include routes such that at any time of the day, 00:00 to 23:59, this route is the fastest way to get to the destination.

When additional layers of routings are requested, additional routings using the same departure or arrival flight may be generated. Each additional layer may include two passes through the Routings flight data. A first pass may remove the departure flights that were included in all routings found so far from consideration in constructing routings and searches again for valid routings using the remaining flights. A second pass may remove the arrival flights that were included in all routings found so far and searches again using the remaining flights. In one embodiment, the results from each layer search are combined and returned to the requester. Layer 1 may includes the best services and those from one additional layer; Layer 2 may include the best services and those from two additional layers and so on. Layer 9 may cause 19 passes by the search engine.

A Template Routing may define the airlines or airline and flight numbers for use in segments of routings for a specific airport pair. The user can define multiple Template Routings for an airport pair. If an airport pair has template routings, routings matching one of the template routings may be returned. A template routing may be limited to a maximum of three connect points (four segments). Template routings may act as filters to further refine the routings returned for a city pair. They may not result in the generation of any additional routings. Template routings may be used to either include or exclude matching routings from those returned for an airport pair. In one embodiment, Template Routings may be limited to the airport pair level of the rule hierarchy. In one embodiment, each template is considered a separate rule. Multiple template routings may be defined for an airport pair. Frequency may also qualify the applicability of a template routing. As an example, a template routing for MSP to BOM could specify the airlines/flights to include or exclude for MSP-ORD, ORD-LHR and LHR-BOM. If an airport pair has template routings, only connection routings complying (based on exclude or include) with the template routings may be returned for routing requests. Non-Stop and direct routings are returned in addition to those connection routings complying with the template routings,

Sort order rules may allow the airline to specify how the returned routings should be sorted. One default sort order may be to prioritize nonstop flights by departure time, then direct flights (including change of gauge) by departure time, followed by nonstop connection by departure time, and finally by connection with direct flights (however with stops) by departure time. For flights that will operate within the European Civil Aviation Conference (ECAC) rules, sort order may prioritize nonstop flights by departure time, followed by direct flights by elapsed flight time, and finally by flights with equipment change en route and connections by elapsed flight time (not distinguishing between two or three segment connections, online or interline connections). This sort order is required for neutral agents such as travel agents. For flights that will operate within the United States Department of Transportation (DOT) rules, the sort order may prioritize nonstop flights by departure time, then direct flights (including change of gauge) by elapsed flight time, followed by two segment interline connections by elapsed flight time (not distinguishing between online or interline connections), and finally by three segment connections by elapsed flight time (not distinguishing between online or interline connections).

In addition to the above sort orders, an airline-specified sort order may be employed, which may further include at least three sort levels: Host, Connection Order, and/or Time. In one embodiment, the Airline Order is used as the primary sort with the Connection Order and the Time Order used as secondary sorts. The Host sort level may orders all routings containing one or more host airline segments prior to any routing not containing a host segment. The Connection Order sort level may sort routings by the number of stops within number of connections in ascending order, which is the default setting. Alternatively, the Connection Order may sort routings by number of connections in the order of online to online, then online to alliance, followed finally by online to non-alliance. Additionally, the Connection Order may not order by connection or stops, but instead use a time order. The Time sort level may sort routings by the departure date and time of the first flight segment in the routing. Alternatively, the Time sort order may sort routings by the arrival date and time of the last flight segment in the routing in ascending order. Optionally, the Time sort order may sort routings by elapsed time in ascending order.

In one embodiment, routings are requested from the Routings Engine. The routings selected may be based on the request options and the rules defined by the airline, if applicable. The selected routings may then be filtered and processed as explained below.

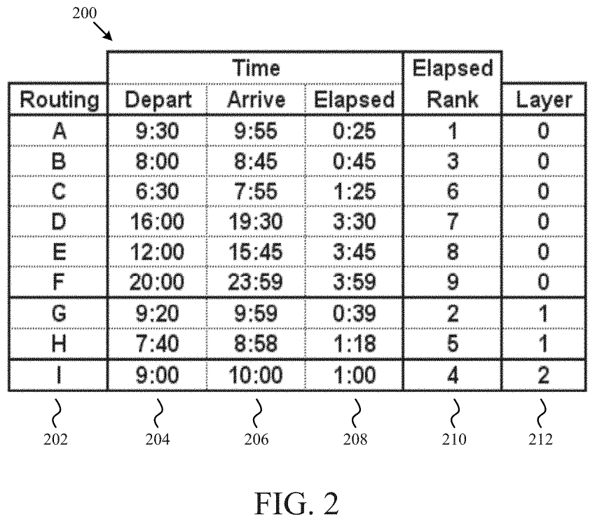

FIG. 2 is a block diagram illustrating flight routings 202 according to one embodiment of the disclosure. The column 208 entitled “Elapsed Rank,” lists the elapsed time of each routing in descending order. Without layers 212, a routings engine may select a routing based solely upon the elapsed rank 208, provided it was within the selected, time period 204 and 206. However, when The Routings Engine incorporates layers 212, the routings preferences change, wherein Routings A through F may be identified as the “best” services (layer 0), G & H as the next best services (layer 1), and I as the next best (layer 2). The Routings Engine may considers Routings A through F to be the set of best services because these services have no other service that both departs later and arrives earlier. Routings G and H are the “best services” of layer 1 because after removing the “best services” of layer 0, the routings G and H are the best services. After removing routings G and H (“best services” of layer 1), routing I becomes the “best service” of layer 2. Routing F ranks last by elapsed time, yet it is the only route available after the noon hour, so the Routings Engine puts it in the set of best services.

In one embodiment, rules for dynamically generating routes in the Flight and Routings module are maintained by exception in order to influence the generated routes. There may be two categories for maintaining the rules: Pre-processing rules, which are defined by Routing generation attributes; and Post processing rules, which are defined by Template routings for an airport pair and/or Sort order of generated routings. After the normal routings are generated for cargo, an additional separate search may be completed for routings that use one or more truck segments, except that truck-to-truck connections may be disallowed. This may allow routings with longer elapsed times to be efficiently generated. Once a constructed route is at the country of destination, the connection possibilities that takes it out of the country to reach the airport of destination are not considered to avoid customs complications.

When a direct segment has a change-of-gauge, cargo connect time (CCT) rules may be used to validate connect times at the change-of-gauge airport(s). On all generated routings, any segment having a change-of-gauge may be separated at the change-of-gauge point(s). Change-of-gauge logic may also apply to flights with SSIM code DEI 210 (change of aircraft without change of equipment).

In one embodiment, and after all routings have been generated, they may be merged and sorted. Routes may be removed from the bottom of the sorted list as needed so that the number of routes returned, is not greater than the MAX_ROUTES_RETURNED parameter in the Flights and Routings module. In one embodiment, no pre-defined user specified parameters are required to construct this best set of routings. The optional rules for Routing Generation Attributes, Template Routing, and Sort Order allow authorized users to adjust the routings information returned for commercial reasons.

In one embodiment, data messages containing information about flight schedules may be received through SSIM, ASM, and/or SSM messages, which may be fed to the Flights and Routings module after they have been successfully processed in the Flight Control module. In one embodiment, the Flight Control module will continue to serve current LMS functions for obtaining flight information on individual flights and maintaining configuration information, which may include managing schedule change processing of affected bookings and shipment information.

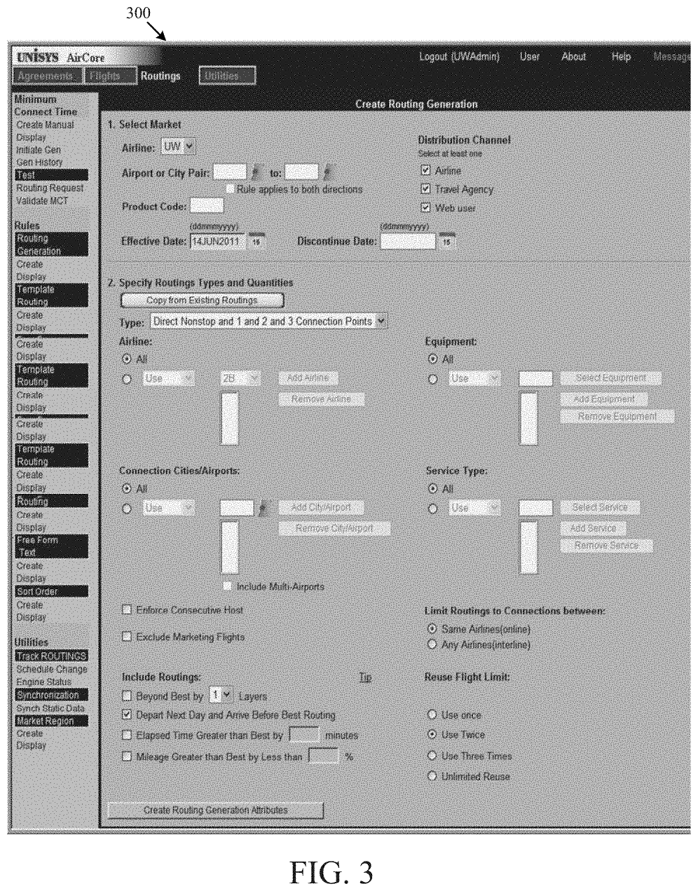

FIG. 3 is a block diagram illustrating a user interface 300 for a Flight and Routing module, used for creating Routing Generation Attributes, according to one embodiment of the disclosure. Routing generation attributes may be allowed at the airline, city pair, or airport pair levels of the rule hierarchy. The routing generation attributes specify what data is used to generate routings, what types of routings are generated and the quantity of the routings. Quantity of routings may be controlled by the routing generation layer, reuse flight limit, maximum elapsed time differential and maximum mileage Differential selections. As illustrated by the user interface in FIG. 3, the Routing Generation Rules provide options to influence the routings that are returned. Attributes may include:
Type of routing to include: Nonstop, Direct, one to three connections (up to four flight segments);
Airlines to include or exclude in a routing;
Connection points to include or exclude in a routing;
Equipment (IATA Equipment Types) to use or exclude in a routing;
Services Type (IATA Service Types) to use or exclude in a routing;
Enforce consecutive host, which prohibits the use of non-partner flights between host flights and/or alliance partners flights (for example, ORD JFK FRA FCO—non-partner flight could use ORDJFK or FRAFCO, but not JFKFRA if the other two flight segments were partner airlines), whereas all the host and alliance partner flights in the routing must be consecutive;
Exclude marketing code share flights;
Exclude interline connections;
Number of layers (one to nine), in which only the best set of routings is returned unless a number of layers beyond one is specified (a setting of two adds the second best set of routings while a setting of three adds the third best set of routings, and so forth);
Depart next day and arrive before best routing, which generally, only allows routings that depart on the requested date to be returned (this option includes routings from the next day if their arrival time is the same or less than arrival time of a routing that departs on the selected date);
Elapsed time greater than best by X minutes, which does not allow routings with elapsed times greater than the least time Connection Routing by the specified number of minutes, wherein the range of valid values for Maximum Elapsed Time Differential is 1 to 5940 (in minutes, which are rounded up to a number of hours, and further, may overrides the default value maintained by the Routings Engine);
Mileage greater than best by less than X %, which does not allow routings with distances (mileage) greater than the least mileage Connection Routing by the specified percent, thereby eliminating some circuitous routings (when this parameter is set to 0.0, it indicates no routings are eliminated while other valid values are 2.0 (200%) through 9.0 (900%), and further, overrides the default value maintained by the Routings Engine; and
Reuse flight limit. Limit the use of a flight/date segment to once, twice, three times or unlimited. The default is twice.

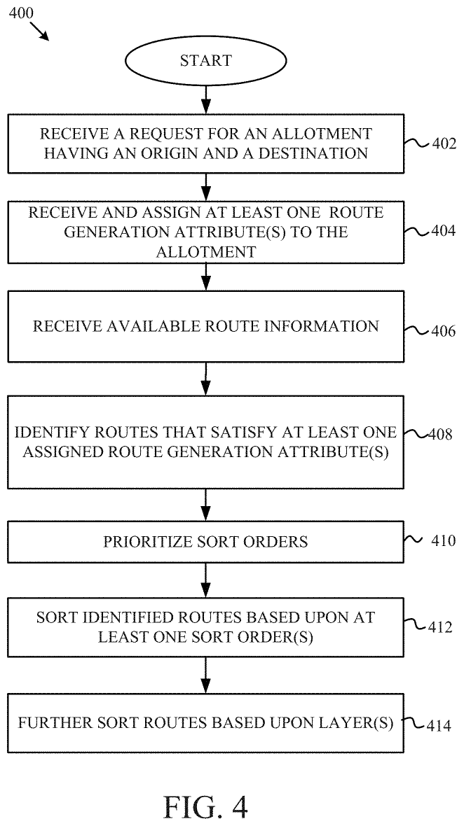

FIG. 4 is a flow chart illustrating a dynamic route generation process according to one embodiment of the disclosure. The method may provide the ability to dynamically generate a route without relying upon overhead of any pre-defined specifications of airport to connect between origin and destination airports. A logistics management system (EMS) is one system for dynamically generating routes. A method 400 begins at block 402, where a request is received, for an allotment having an origin and a destination. A request may be received by a server from a requestor. At block 404, at least one route generation attribute is received, which is assigned to the allotment. At block 406, available route information is received. In some embodiments, an additional step of requesting available route information may precede block 406. In one embodiment, a request for route information may include specific route information, as shown in block 402, along with time. However, available route information may also be continuously fed, thereby not requiring a request for information. At block 408, routes that satisfy the request for an allotment having an origin and a destination, as well as any assigned route generation attribute(s) 404, are identified. At block 410, sort orders are prioritized. At block 412, the identified routes are sorted based upon at least one sort order. Optionally, the routes are sorted based upon identified layers, as shown in block 414.

In one embodiment of an LMS, certain information may be synchronized between the LMS and the Flights and Routings module. Such information (data) may include semi-static information for countries, states, airports, cities, airlines, and/or equipment codes. A LMS may be configured to retrieve this information from the Flight Control, Cargo, or the Base modules, which may be done using a user interface. A LMS may be configured, to update this data, and further, may be configured to automatically synchronize the data between both the LMS and the Flights and Routings module. Connection Time changes may be routed through LMS to the Flights and Routings module. This may ensure that the corresponding information is available for subsequent route requests. In order to reduce implementation risk, the changes may be reflected in LMS for the transition time. In one embodiment, the following Flights and Routings maintenance functions may be accessed outside of a LMS by the Flights and Routings system administrator: Routing Generation Attributes, Routing Templates, and/or Routing Sort Order. In one embodiment, the introduction of the Flights and Routing modules also requires the Shared, Utilities, and Agreements modules.

Users and administrators may have different privileges. For example, some users may be granted only creation and viewing access for allotment bookings. However, administrators may be granted rights for viewing, updating, and deleting allotment bookings. This updating may include changing the terms of a hard block or soft block reservation. Sonic administrators may have more limited rights, such as only splitting allotments into two or more separate allotment bookings.

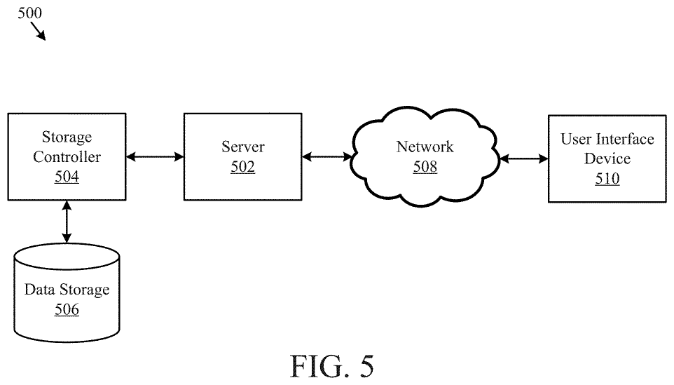

FIG. 5 illustrates one embodiment of a system 500 for an information system, such as a logistics management system (LMS). The system 500 may include a server 502, a data storage device 506, a network 508, and a user interface device 510. The server 502 may be a dedicated server or one server in a cloud computing system. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (RDA) or tablet computer, a smartphone or other a mobile communication device having access to the network 508. In a further embodiment, the user interface device 510 may access the Internet or other wide area or local area network to access a web application or web service hosted by the server 502 and provide a user interface for enabling a user to enter or receive information.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, with one another.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS). In this embodiment, the user interface device 510 may be a computer executing a Java application making requests to a JBOSS server executing on a Linux server, which fulfills the requests by accessing a relational database management system (RDMS) on a mainframe server.

In one embodiment, the server 502 is configured to store databases, pages, tables, and/or records. Additionally, scripts on the server 502 may access data stored in the data storage device 506 via a storage area network (SAN) connection, a LAN, or a data bus. The data storage device 506 may include, for example, a hard disk, including hard disks arranged in an redundant array of independent disks (RAID) array, a tape storage drive comprising a physical or virtual magnetic tape data storage device, or an optical storage device. The data may be arranged in a database and accessible through structured query language (SQL) queries, or other data base query languages or operations.

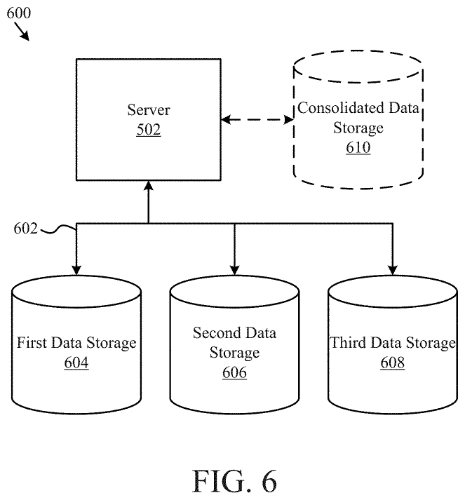

FIG. 6 illustrates one embodiment of a data management system 600 configured to store application parameters and documentation. In one embodiment, the data management system 600 may include the server 502. The server 502 may be coupled to a data-bus 602. In one embodiment, the data management system 600 may also include a first data storage device 604, a second data storage device 606, and/or a third data storage device 608. In further embodiments, the data management system 600 may include additional data storage devices (not shown). In such an embodiment, each data storage device 604, 606, and 608 may each host a separate database that may, in conjunction with the other databases, contain redundant data. Alternatively, a database may be spread across storage devices 604, 606, and 608 using database partitioning or some other mechanism. Alternatively, the storage devices 604, 606, and 608 may be arranged in a RAID configuration for storing a database or databases that may contain redundant data. Data may be stored in the storage devices 604, 606, 608, 610 in a database management system (DBMS), a relational database management system (RDMS), an object oriented database management system (OODMS), an indexed sequential access method (ISAM) database, a multi-sequential access method (MSAM) database, a conference on data systems languages (CODASYL) database, or other database system.

In one embodiment, the server 502 may submit a query to select data from the storage devices 604 and 606. The server 402 may store consolidated data sets in a consolidated data storage device 610. In such an embodiment, the server 402 may refer back to the consolidated data storage device 610 to obtain a set of records. Alternatively, the server 502 may query each of the data storage devices 604, 606, and 608 independently or in a distributed query to obtain the set of data elements. In another alternative embodiment, multiple databases may be stored on a single consolidated data storage device 610.

In various embodiments, the server 502 may communicate with the data storage devices 604, 606, and 608 over the data-bus 602. The data-bus 602 may comprise a storage area network (SAN), a local area network (LAN), or the like. The communication infrastructure may include Ethernet, fibre-channel arbitrated loop (FC-AL), fibre-channel over Ethernet (FCoE), small computer system interface (SCSI), internet small computer system interface (iSCSI), serial advanced technology attachment (SATA), advanced technology attachment (ATA), cloud attached storage, and/or other similar data communication schemes associated with data storage and communication. For example, the server 502 may communicate indirectly with the data storage devices 604, 606, 608, and 610 by first communicating with a storage server (not shown) or the storage controller 504. The server 502 may execute software for the LMS and the CRO or the LMS and CRO applications may execute on two or more different servers (not shown) coupled by the network 508.

The server 502 may include modules for interfacing with the data storage devices 604, 606, 608, and 610, may include modules for interfacing with the network 508, and/or modules for interfacing with a user through the user interface device 510. In a farther embodiment, the server 502 may host an engine, application plug-in, or application programming interface (API).

FIG. 12 illustrates a computer system 700 adapted according to certain embodiments of the server 502 and/or the user interface device 510. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the modules and operations as described herein. The CPU 702 may execute the various logical instructions according to the present embodiments.

The computer system 700 also may include random access memory (RAM) 708, which may be synchronous RAM (SRAM), dynamic RAM (DRAM), and/or synchronous dynamic RAM (SDRAM). The computer system 700 may utilize RAM 708 to store the various data structures used by a software application such as databases, tables, and/or records. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUT) associated with a software or web-based application on a display device 724, such as a monitor or touch screen.

The 110 adapter 710 may couple one or more storage devices 712, such as one or more of a hard drive, a flash drive, a compact disc (CD) drive, a floppy disk drive, and a tape drive, to the computer system 700. The communications adapter 714 may be adapted to couple the computer system 700 to the network 508, which may be one or more of a LAN, WAN, and/or the Internet. The communications adapter 711 may be adapted to couple the computer system 700 to a storage device 712. The user interface adapter 716 couples user input devices, such as a keyboard 720, a pointing device 718, and/or a touch screen (not shown) to the computer system 700. The display adapter 722 may be driven by the CPU 1202 to control the display on the display device 724.

The applications of the present disclosure are not limited to the architecture of computer system 700. Rather the computer system 700 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined, by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for increasing the system efficiency of a machine-implemented logistics management system (LMS) that includes a server having a processor coupled to a non-transitory computer-readable memory, the method comprising:
executing, at the LMS, a flights and routings module, the flights and routings module includes following configurable parameters: Segment Use Limit, Layers, Extra Elapsed, Trucks Elapsed Time Separate, FastreturnNDouble, and FastReturnNSingle;
receiving, at the LMS, a reservation request from a requestor for an allotment reservation having an origin and a destination;
receiving, at the LMS, at least one route generation attribute;
assigning, by the LMS, at least one route generation attribute to the allotment reservation;
receiving, by the LMS, available routes that have the same origin and destination as the reservation request;
assigning, by the LMS, a template routing rule to at least one of the origin and the destination, in which the template routing rule limits at least one of airlines and flight numbers;
limiting, by the LMS, the identified routes to those that satisfy the template route rule;
identifying, by the LMS, routes from the received available routes that satisfy at least one route generation attribute;
sorting, by the LMS, the identified routes based upon at least one sort order; and
booking, by the LMS, the allotment reservation on a specific identified route, based at least in part on the sorting, and shipping cargo in accordance with the allotment reservation.

2. The method of claim 1, further comprising:
sorting, by the LMS, routes using layers.

3. The method of claim 2, in which sorting the routes using layers comprises: a first pass that removes departure flights that were included in the identified routes; and a second pass that removes arrival flights that were included in the identified routes.

4. The method of claim 1, further comprising after the assigning:
requesting, at the LMS, available routes that have the same origin and destination as the reservation request.

5. The method of claim 1, in which at least one sort order prioritizes nonstop flights by departure time, then direct flights by departure time, then by connection with direct flights by departure time, and finally by connection with direct flights by departure time.

6. A computer program product, comprising:
a non-transitory computer readable medium comprising instructions that, when executed on a processor-based logistics management system (LMS), cause the LMS to perform operations including:
executing, at the LMS, a flights and routings module, the flights and routings module includes following configurable parameters: Segment Use Limit, Layers, Extra Elapsed, Trucks Elapsed Time Separate, FastreturnNDouble, and FastReturnNSingle;
receiving, at the LMS, a reservation request from a requestor for an allotment reservation having an origin and a destination;
receiving, at the LMS, at least one route generation attribute;
assigning, by the LMS, at least one route generation attribute to the allotment reservation;
receiving, by the LMS, available routes that have the same origin and destination as the reservation request;
assigning, by the LMS, a template routing rule to at least one of the origin and the destination, in which the template routing rule limits at least one of airlines and flight numbers;
limiting, by the LMS, the identified routes to those that satisfy the template route rule;
identifying, by the LMS, routes from the received available routes that satisfy at least one route generation attribute;
sorting, by the LMS, the identified routes based upon at least one sort order; and
booking, by the LMS, the allotment reservation on a specific identified route, based at least in part on the sorting, and shipping cargo in accordance with the allotment reservation.

7. The computer program product of claim 6, wherein the instructions include code to perform:
sorting, by the LMS, routes using layers, comprising:
performing a first pass that removes departure flights that were included in the identified routes; and
performing a second pass that removes arrival flights that were included in the identified routes.

8. The computer program product of claim 7, wherein, the instructions include code to perform, after the assigning:
requesting, at the LMS, available routes that have the same origin and destination as the reservation request.

9. The computer program product of claim 6, wherein at least one sort order prioritizes nonstop flights by departure time, then direct flights by departure time, then by connection by departure time, and finally by connection with direct flights by departure time.

10. The computer program product of claim 6, wherein the instructions include code to perform:
blocking, by the LMS, the selection of a different agreement after the allotment reservation is created.

11. An apparatus for a logistics management system, comprising:
a memory; and
at least one processor coupled to the memory, the at least one processor configured to execute operations including:
executing, at the LMS, a flights and routings module, the flights and routings module includes following configurable parameters: Segment Use Limit, Layers, Extra Elapsed, Trucks Elapsed Time Separate, FastreturnNDouble, and FastReturnNSingle;
receiving, at the LMS, a reservation request from a requestor for an allotment reservation having an origin and a destination;
receiving, at the LMS, at least one route generation attribute;
assigning, by the LMS, at least one route generation attribute to the allotment reservation;
receiving, by the LMS, available routes that have the same origin and destination as the reservation request;
assigning, by the LMS, a template routing rule to at least one of the origin and the destination, in which the template routing rule limits at least one of airlines and flight numbers;
limiting, by the LMS, the identified routes to those that satisfy the template route rule;
identifying, by the LMS, routes from the received available routes that satisfy at least one route generation attribute;
sorting, by the LMS, the identified routes based upon at least one sort order; and
booking, by the LMS, the allotment reservation on a specific identified route, based at least in part on the sorting, and shipping cargo in accordance with the allotment reservation.

12. The apparatus of claim 11, wherein the processor is further configured to execute:
sorting, by the LMS, routes using layers, comprising:
performing a first pass that removes departure flights that were included in the identified routes; and
performing a second pass that removes arrival flights that were included in the identified routes.

13. The apparatus of claim 11, wherein the processor is further configured to, after performing the assigning,
requesting, at the LMS, available routes that have the same origin and destination as the reservation request.

14. The apparatus of claim 11, wherein at least one sort order prioritizes nonstop flights by departure time, then direct flights by departure time, then by connection by departure time, and finally by connection with direct flights by departure time.

15. The apparatus of claim 11, in which the processor is further configured to execute:
blocking, by the server, the selection of a different agreement after the allotment reservation is created.
